(19) United States
(12) Patent Application Publication
(10) Pub. No.: US 2006/0204311 A1
(43) Pub. Date: Sep. 14, 2006

(54) High tech typewriter system

(76) Inventor: Wynter Shynet Hawkins, Norfolk, VA (US)

Correspondence Address: Wynter S. Hawkins, 4907 Shafer Street, Norfolk, VA, 23513, US

(21) Appl. No.: 11/371,067

(22) Filed: Mar. 9, 2006

Related U.S. Application Data
(60) Provisional application No. 60/660,234, filed on Mar. 11, 2005.

(51) Int. Cl. B41J 29/00; G06F 3/023

(52) U.S. Cl. 400/693; 400/472

(57) ABSTRACT

This invention relates to an integrated system that combines the functions of a typewriter, computer keyboard, compact printing device, a compact scanning device in conjunction with a monitor and computer. This system allows for paper/documents to be scanned through typewriter, automatically placed in position to begin typing, as typing function begins images and/or text are displayed on computer monitor as well as simultaneously placed or edited on a page visible to user. A digital representation of the printed material in digital format is shown on computer monitor for hard copy production, data storage and/or editing. The convenience of having a typewriter system that allows user to visually see printed or edited images and/or text as keys are struck, located within the personal computer system provides for an improved method of utilizing time, space, and technology to an optimum.

### BACKGROUND OF THE INVENTION

Office documents, such as forms, letters and various documents are generally mechanically or electronically produced using typewriters, word processors or computers. Although many documents can be generated digitally, there remains a need in many home and office environments to use a typewriter to fill out forms or to type information into pre-printed documents. In addition, many typewriters have a separate ribbon segment that removes ink impressions from paper, permitting the user to erase text, other typewriters permit rudimentary editing of text before printing, through the use of a small liquid crystal display window. This is cumbersome and time consuming when compared to computer or word processor editing. Furthermore, mechanical typewriters are limited in the choices of characters that may be produced.

The present invention is an integrated system that provides functions common to a typewriter, printer, scanner, monitor and computer. The user is able to place unlimited styles of text or images, simultaneously, on both paper and monitor in the relative location of the keyboard. The user may also choose to compose the entire document before printing. The present invention allows for an entire page or many pages to be displayed on the monitor for editing before printing. The present invention is compact enough to replace a standard keyboard and does not require any additional devices.

### DESCRIPTION OF PRIOR ART

Scanners have been used to convert pictures or text into a digital format. Typewriters provide immediate production of a hard copy and allow for exact placement of text in forms and documents. Printers in combination with computers, allow for the editing of entire documents before printing. There is not a device that specifically addresses the need to combine the functions of a scanner, typewriter, printer, monitor and computer.

Examples of prior art devices include:
(a) UNITED STATES PATENT APPLICATION: JP62186369A2 refers to a multi-function personal word processor. The device scans and displays images, then prints characters where desired. This technology is useful for scanning, displaying, then printing where desired. It does not, however, have the ability to show the image or text to be printed, on both the paper and a computer monitor simultaneously.
(b) U.S. Patent Number EP0012881B1 describes a device for automatic margin setting in a typewriter. The device depends upon the width of the paper, and scans the paper edge using sensors. The device is an improvement to an existing invention, whereas the present invention integrates a set of existing technologies into a system, thus providing increased utility.
(c) U.S. Pat. No. 6,428,222 is a device for automatic margin setting in a typewriter, also dependent upon the width of the paper. The device scans paper for unwanted marks using sensors and the sets margins. As with the former description of prior art, the device is an improvement to an existing invention, whereas the present invention integrates a set of existing technologies into a system, thus providing increased utility.
(d) U.S. Pat. No. 4,620,808 is a device that discloses a display typewriter for utilizing the features of a word processor with a typewriter-like configuration. However this device does not use a scanner to scan in the document prior to entering data and then displaying the form on the monitor for entry of data into and therefore does not illustrate all the structure of the present invention.

There continues to be a need for a new and improved device incorporating scanning, typing, graphic placement, editing, and printing into a system, with the ability to locate text and images in forms and documents and the ability to produce immediate hard copy in conjunction with the personal computer system.

### OBJECTS AND ADVANTAGES

Several objectives and advantages of the present patent are:
(a) to provide a method of rendering print material visible to the user, simultaneously on a page and on a computer monitor.
(b) to provide a method of combining typewriter, scanner, printer, monitor and computer functions into a system.
(c) to avoid secondary or remote typewriters, printers and scanning devices.
(d) to provide a convenient means of editing while maintaining the option of immediate print.

(e) to provide a solution that is convenient, effective and simple to use.

References Cited

| U.S. Patent Documents | |
|---|---|
| 4,768,164 8/1988 Dreher | 400/70 |
| 4,971,461 11/1990 Kato, et al | 400/61 |
| 4,755,070 7/1988 Cerutti | 400/692 |
| 4,826,332 5/1989 Ukai, et al | 358/1.11 |
| 4,837,712 6/1989 Shibamiya | 400/70 |
| 4,976,559 12/1990 Inagaki | 400/693 |
| 6,304,629 10/2001 Conway, et al | 198/502 |

### BRIEF SUMMARY OF THE INVENTION

The primary object of the present invention is to provide an improved method combining the functions of a typewriter, scanner, printer, monitor and computer as a means for rendering print material immediately.

An additional object is to provide printed material onto a page that is visible to the user, as it is typed or otherwise create while simultaneously creating a digital representation of the print material in digital format on a computer monitor that can be edited, stored and retrieved.

Still another object is to eliminate additional equipment and provide a convenient method of combining a keyboard, compact scanning device, compact printing device, monitor and computer functions into a system for easy and simple use.

A related object of the present invention is to provide users the option to keep existing keyboard and have immediate print available that combines a compact scanning device, compact printing device into a machine that is not cumbersome.

It is yet another object of the present invention is to allow printing function within a laptop computer integrating the functions of a typewriter, scanner, printer, monitor and computer.

### DRAWING FIGURES

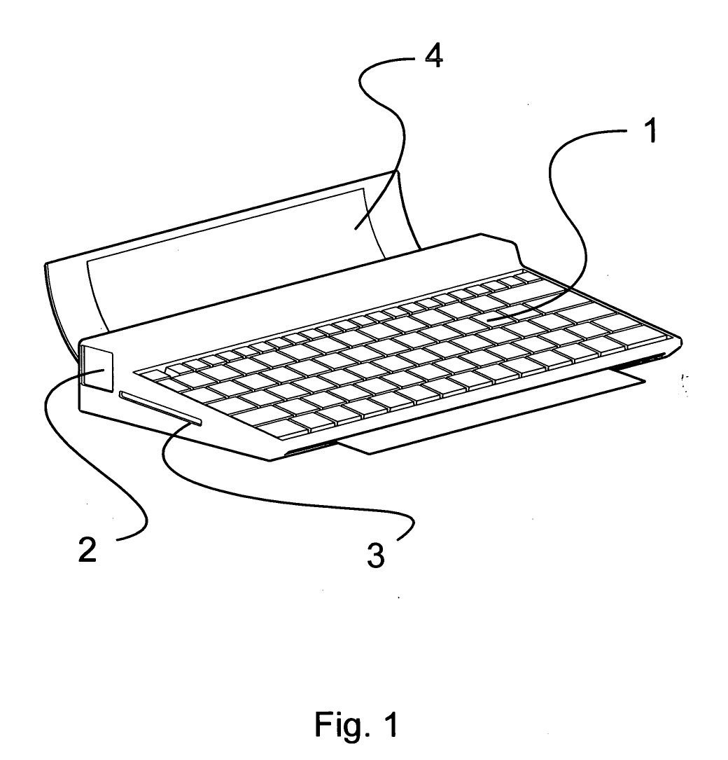

1. FIG. 1 shows a perspective view of the proposed invention with scanning device in at the top of the keyboard.

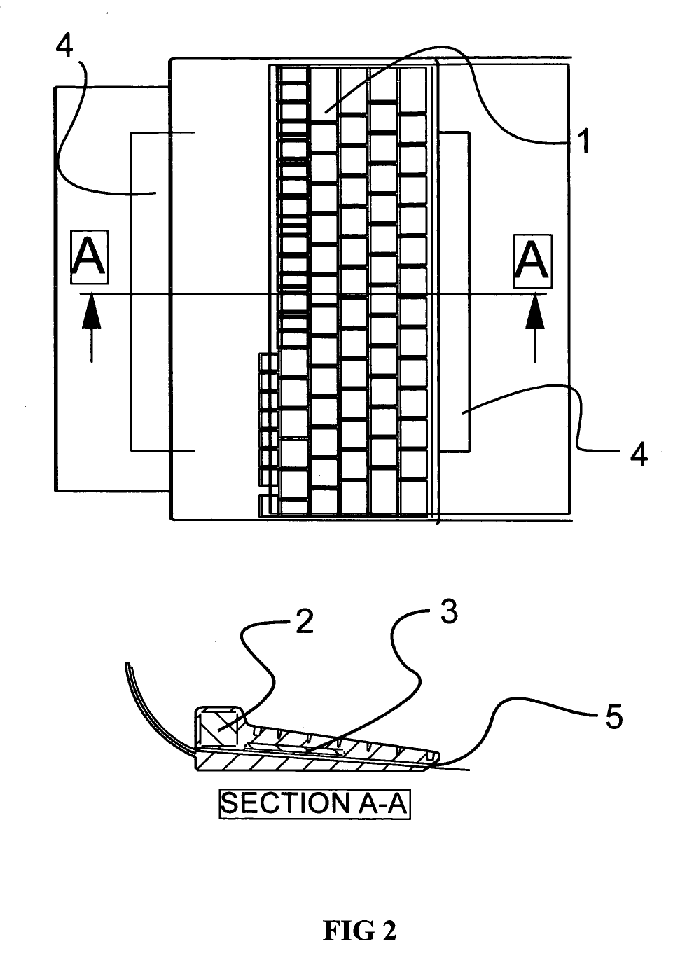

2. FIG. 2 shows a front, top and section view of the proposed invention with the scanning device at the top of the keyboard.

3. FIG. 1 shows a perspective view of the proposed invention with scanning device under the keyboard.

4. FIG. 2 shows a front, top and section view of the proposed invention with scanning device under the keyboard.

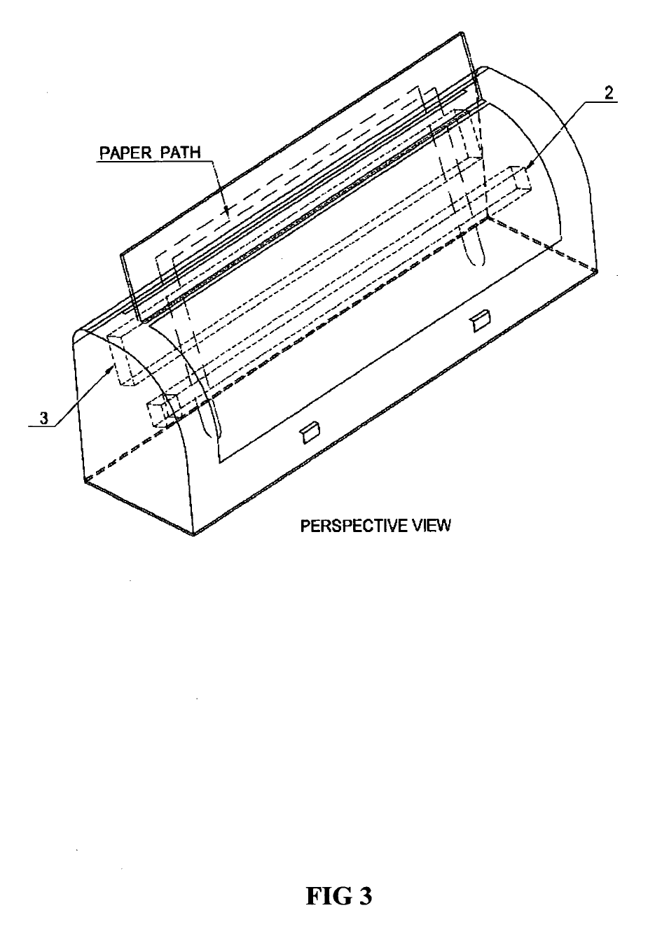

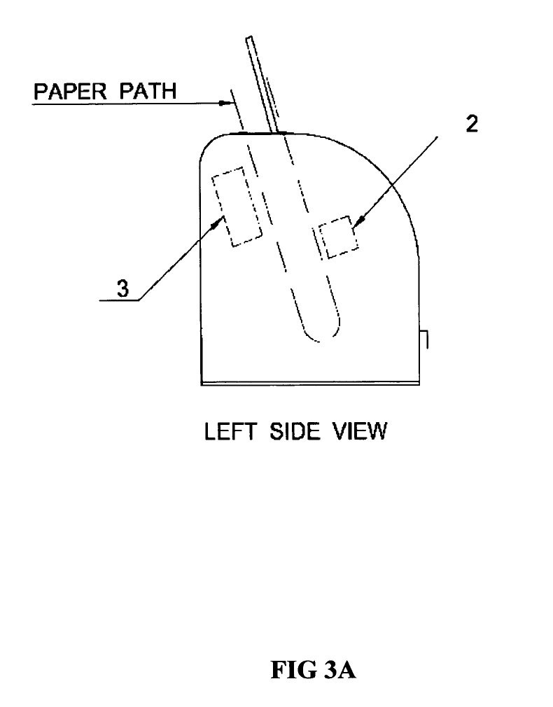

5. FIG. 3 shows a perspective view of the proposed invention with a scanning and printing device without a keyboard.

6. FIG. 3A shows a section view of the proposed invention with a scanning and printing device without a keyboard

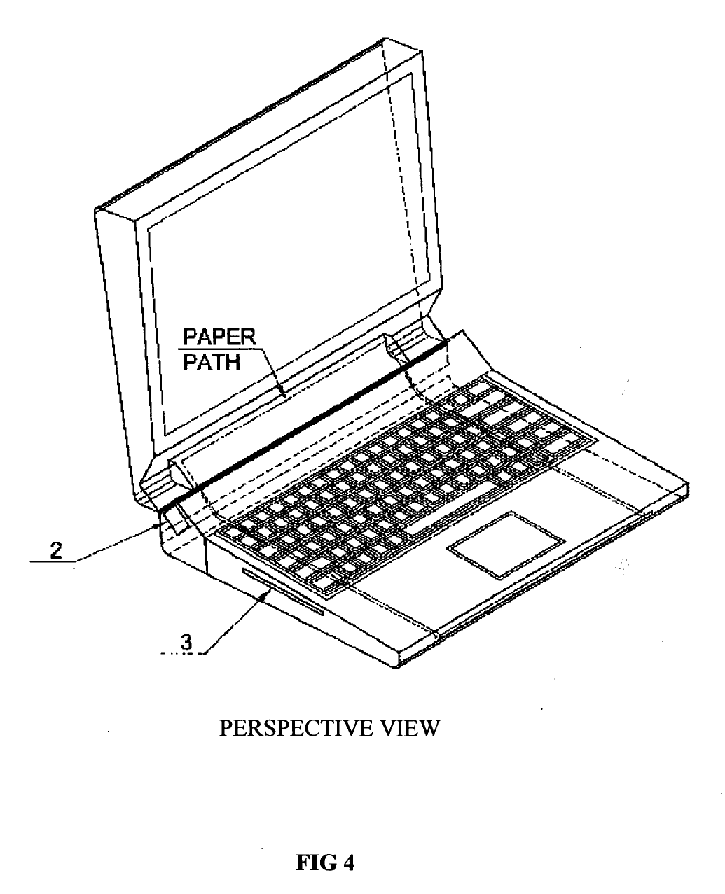

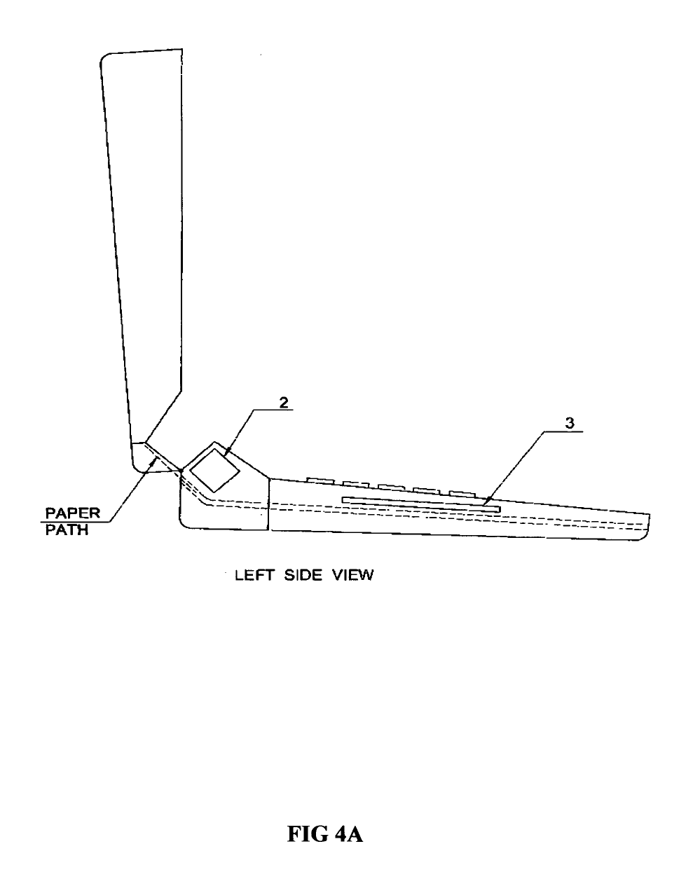

7. FIG. 4 shows a perspective view of the proposed invention within a laptop.

8. FIG. 4A shows a section view of the proposed invention within a laptop.

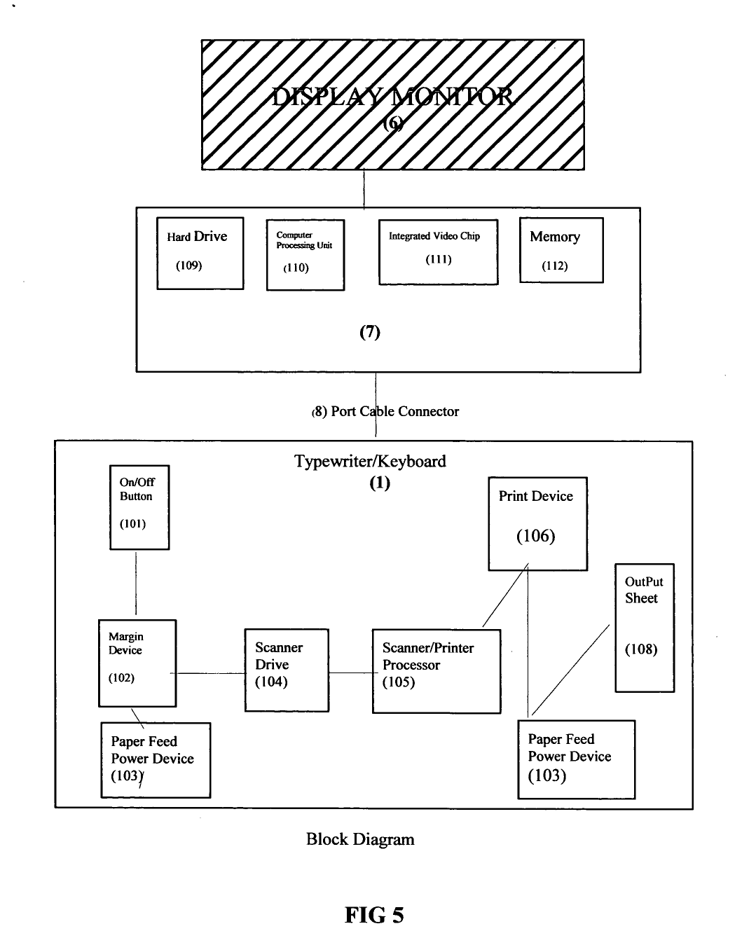

9. FIG. 5 a Block Diagram shows the integrated system of proposed invention.

### DESCRIPTION OF THE INVENTION

The proposed invention provides, in combination, the functions of a typewriter, a standard computer keyboard 1 the functions of a compact printing device 2, the functions of a compact scanning device 3, and the functions of a computer 7 and monitor, 6 as a means of simultaneously typing or otherwise placing text or images on a printed page and on a computer monitor for hard copy production, data storage, and/or editing as shown in FIG. 1, 2. A System that allows an automatic margin setter 102 used in conjunction with rollers, gears 103 and paper sensors that automatically detect paper size when paper is inserted. Paper 4 is adjusted, aligned and placed in position to be scanned. As paper 4 moves through said invention by a paper-feed power device 103, the entire document is scanned 104 through. A compact scanner 3 is also included and is also similar to prior art for scanners and digital reproductive devices, scanner 3 then sends images and/or text to the scanner/printer processor 105. The scanner/printer processor 105 formats the collected images and/or text into Pixel that converts images and/or text to a video card 111 for display on monitor 6 while simultaneously sending data through the computer processor 110 to the hard drive 109 for editing. The typewriter technology is similar to that which is customary in prior art of keyboards or typewriters, having the general layout of a common keyboard connected to a microprocessor and controller circuitry. Located underneath the keyboard 1 is a key matrix that is monitored by a processor 105. As the typing keys are struck the processor 105 analyze the key matrix and interprets what text to send to the printing device 106, monitor 6 and computer 7. A common keyboard connector cable 8, sends data through to the other end of the cable that connects to a computer port 8, there are no lapse of time between when the keys are struck and when the text appear on the monitor 6 and placed on document if desired. Also included is a compact printing device 2 as is customary in prior art of printers and various mechanical and electronic typewriters such as a compact print cartridge, smaller ink-jet, thermal printer, serial dot-matrix impact printers or other printers occupying smaller space 106 that is used to place the text on the document. Part of the proposed invention does not integrate a computer 7, monitor 6 and keyboard 1 as a system although it is a system that is used in conjunction with a computer 7, monitor 6 and keyboard 1 as shown in FIG. 3, 3A. However the part of the proposed invention in relation to a Laptop with internal connectors does integrate a computer, monitor and keyboard as part of a system as shown in FIG. 4, 4A. A paper path 5 allows for placement of paper in proximity of the scanning 104 and printing device 105, and then placed in a convenient position for the user to see while typing. The proposed invention includes devices to move the paper 103 as are common with prior powered paper-feed rollers and gears 103 to eject paper output sheet 108 onto output tray, once typing function is completed.

### OPERATION OF THE INVENTION

The user places paper in the paper slot at the beginning of the paper path 5. Common devices move the paper along the paper path 103 past the scanner. The scanner 3 digitizes the document allowing text or images on the paper to be recorded and displayed 111 on the computer monitor 6. The user may choose to create and edit the document before printing 106 as is performed with standard word processors and computers or edit the document while printing. The primary benefit of the proposed invention is realized as the user types as one would with a standard typewriter in the relative position to the computer keyboard 1, thus printing 106 images and/or text directly, or immediately, onto the page 108. In this instance, text is printed 106 at the same moment that the keys on the keyboard 1 are struck, a digital representation is placed on the monitor screen 6, allowing the user to produce a hard copy 108 of a document while simultaneously producing a digital copy 112.

1) A typewriting system that is used in relative position to a computer keyboard in conjunction with a computer system that allows images and text to be placed and edited simultaneously on paper and shown on a computer monitor for data storage, data retrieval, hard copy production and/or editing.

2) A Compact printing mechanism used as according to claim 1.

3) A Compact scanning mechanism used in connection with a typing system according to claim 1.

4) Software that allows the integrating of a typing, scanning, printing, monitor and computer system to function simultaneously according to claim 1.

5) A system with automatic margin setting that allows paper placed within the typewriting system to be placed in proper position in conjunction to the typing mechanism and visible to user according to claim 1.

6) Typewriting system with a compact printing mechanism, compact scanning mechanism, wherein the keyboard, monitor and computer is separate but used in conjunction as according to claim 1. (As shown in FIG. 3, 3A)

7) Typewriting system integrated into a laptop computer with functions as described in claim 1. (As shown in FIG. 4, 4A)
